(19) United States
(12) Patent Application Publication
(10) Pub. No.: US 2013/0232042 A1
(43) Pub. Date: Sep. 5, 2013

(54) SYSTEM AND METHOD FOR COMPUTER-IMPLEMENTED ACCOUNTING SERVICES PROVIDED USING CLOUD RESOURCES

(71) Applicants: Thomas Kirk Simpson, Toronto (CA); James Lochrie, Calgary (CA)

(72) Inventors: Thomas Kirk Simpson, Toronto (CA); James Lochrie, Calgary (CA)

(21) Appl. No.: 13/884,139

(22) PCT Filed: Nov. 8, 2011
(86) PCT No.: PCT/CA2011/001223

§ 371 Date: May 8, 2013

Related U.S. Application Data
(60) Provisional application No. 61/411,352, filed on Nov. 8, 2010.

(51) Int. Cl. G06Q 40/00

(52) U.S. Cl. CPC G06Q 40/10
USPC 705/30

(57) ABSTRACT

A system, computer program and method is provided for providing computer-implemented accounting services is provided. The system includes an external cloud based computing environment that is operable to provide access to one or more subscribers to one or more computer-implemented accounting or bookkeeping services. The cloud based computing environment being operable to enable (A) the capture of financial information from multiple sources including based on captured user interactions relative to financial information capture and/or business processes based on analysis of such captured user interactions, (B) the processing of the financial information based on at least one accounting utility to provide accounting information or bookkeeping information, (C) store the accounting information for access by the appropriate subscriber or subscriber designee, and (D) enable access to the accounting information for accounting, business management, and/or financial purposes on an on demand basis via one or more permitted network connected devices.

### FIELD OF THE INVENTION

This invention relates generally to accounting software applications and platforms. This invention relates more generally to accounting software applications and platforms targeted to smaller or medium size businesses.

### BACKGROUND OF THE INVENTION

In the U.S. there are over 21 million single-person businesses plus another 4.4 million businesses with fewer than 20 employees. In Canada, more than 11,000 new small businesses are created each month, not including self-employed entrepreneurs.

Small businesses account for 60% or more of global GDP, and about 70% of total worldwide employment. Small to medium sized businesses (“SMBs”) account for 72% of employment in China, 73% in India, and over 80% in Latin America. In Canada 2.63 million Canadians are self-employed, up 10% over the last decade and there are more than 1 million small businesses that have fewer than 50 employees.

No business owner likes to spend time accounting and very few do it properly. Most small businesses would like a better picture of their day to day finances but will not or cannot practically invest the time and money in software tools that will transform mundane data into insight.

Meanwhile, there are several emerging trends and technologies that can help a small business or medium business owner do more with their accounting, better, more easily, and in a far more user friendly environment. These trends and technologies include:
Growth of online computing applications (cloud computing/SaaS).
Ease of connectivity and collaboration.
The ability to leverage online sources of data to avoid manual inputting financial information. This ability alone will save time and reduce human error, making accounting easier and better for small businesses.

The continuing growth of cloud applications, or Software-as-a-Service (“SaaS”) signals a shift away from install-and-update computer applications. The growth of netbook computers validates this trend. A 2009 Microsoft survey found that small and midsized businesses were predicting a 20% increase in SaaS use last year alone.

There are compelling reasons for a small business to adopt SaaS solutions. Cost, productivity, distributed knowledge (work anywhere) and collaboration are a few of the advantages. The Microsoft Small Business Technology Index 2010 showed that businesses using cloud technology are much more likely to report an increase in revenue.

Although there is a lot of media coverage around privacy and security concerns with online applications, generally speaking businesses and consumers appear to be more comfortable with use of accessing services offered based on SaaS models.

Existing accounting applications were designed primarily for accountants not for business owners. As a result, 67% of small businesses still use spreadsheets to manage their money. Accounting becomes a chore and small business owners avoid doing their books, they don't take advantage of the data they are collecting and what they produce is of limited use to an accountant.

One company offering accounting software is QuickBooks™. QuickBooks by some reports has 85% market share for desktop software. Other software packages, such as Simply Accounting, exist but don't show any sign of eating into QuickBook's lead.

By some reports, 64% (about 18.6 million) of small businesses use spreadsheets or less sophisticated solutions. The remaining 36% (10.4 million) use some sort of accounting application (most use QuickBooks).

Spreadsheets are cumbersome as accounting solutions and few small business owners have the time to design or use a proper spreadsheet.

There are several companies in the online accounting space with Xero™ leading the group but it has only managed to attract 17,000 paying clients in three years. Inertia is a strong motivating factor in accounting software decisions. People stay with what they know, because changing is time consuming and nobody likes accounting in the first place, so why go through more pain than you need?

There is a need for accounting technology services that leverage SaaS service models, that are cost effective, and address bathers to adoption including inertia as described and the need of the ability to integrate existing accounting data in a flexible and user friendly way.

### SUMMARY OF THE INVENTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect of the invention, a software platform is provided, delivering computer implemented, web accessible accounting services, based on a SaaS model.

In another aspect of the present invention, there is provided an Internet network implemented system for providing computer-implemented accounting services characterized in that the system comprises:
(a) an external cloud based computing system defining a cloud based computing environment that is operable to provide access to one or more subscribers to one or more computer-implemented accounting or bookkeeping services;
(b) the cloud based computing system defining:
   (i) a financial information capture tool that is operable to (A) capture financial information from one or more remote Internet connected platforms, sources including based on captured user interactions relative to financial information capture and/or business processes based on analysis of such captured user interactions, and enable one or more users or subscriber users to otherwise provide financial information, (B) enable the definition of a profile based on the business of a subscriber business or subscriber profile;
   (ii) a categorization tool, linked to the financial information capture tool, that enables the categorization of financial information based on the subscriber profile and also based on one or more accounting or bookkeeping processes linked to the subscriber profile, wherein the categorization tool enables: (A) automated categorization of financial information, and (B) if automated categorization of particular financial information did not result in a categorization, then enables manual categorization of the particular financial information; and
   (iii) an accounting or bookkeeping utility that is operable to process the categorized financial information based one or more accounting and/or bookkeeping processes associated with the subscriber so as to generate, and enable the subscriber to access, accounting information or bookkeeping information.

In another aspect of the present invention, there is provided the computing system further defining learning engine that implements one or more machine learning processes that enable:
(c) the automated categorization of financial information;
(d) the analysis of automated categorization of financial information, including based on user feedback (including manual categorization of financial information by the user or users), so as to alter the automated categorization processes associated with the subscriber; and/or
(e) the modification of the subscriber profile based on learning from user interactions with the system, and processing of financial information for the subscriber, including automated categorization of financial information.

In another particular aspect of the present invention, there is provided the system characterized in that the cloud based computing system further defines an administrative utility that enables a subscriber business to delegate user activities related to the system to one or more accountants or bookkeepers, which enables such delegates to teach the system and thereby enabling the use of the system by subscriber staff to be streamlined.

In another aspect of the present invention, there is provided the system characterized in that the system is configured to enable subscribers users to provide or categorize financial information required for accounting and/or bookkeeping processes in an efficient way, and the system thus is able to build and maintain an up to date financial information for the business.

In yet another aspect of the present invention, there is provided the system characterized in that the system further defines one or financial analysis tools that enables the subscriber users to generate up to date financial reports on an on demand basis.

### DESCRIPTION OF THE DRAWINGS

FIG. 1 depicts an exemplary system diagram illustrating structure of a system in accordance with one embodiment of the present invention.

FIG. 2 depicts one aspect of a workflow of the present invention.

FIG. 3 illustrates a representative implementation of the system of the present invention.

### DETAILED DESCRIPTION OF PREFERRED EMBODIMENTS

The following terms are used throughout the description, the definitions of which are provided herein to assist in understanding various aspects of the subject innovation. It is to be understood that the definitions are not intended to limit the scope of the disclosure and claims appended hereto in any way.

As described in the summary, the present invention provides a system, computer program, and method for accessing accounting services via a cloud computer environment. The service provided using the present invention, which may be provided on a SaaS basis, provides an effective computer implemented accounting solution, which may be used for example by smaller businesses (for example businesses having 9 or fewer people).

The Internet implemented accounting platform (10) of the present invention may be implemented using a cloud implemented network architecture, which may be based on a web application (12). The web application (12) may be implemented so as to provide cloud based resources that correspond to the functions and operation described below, implemented in a manner that is known.

The web application (12) may be understood to include the following key utility: a financial information capture tool (14) and an accounting utility or bookkeeping utility (16). The web application (12) includes or is linked to administrative utility (17), which for example the business owner may configure to enable third parties to access selected functions of the platform. Significantly, this may enable for example a business owner to delegate initial work using the platform (such as the capture of financial information and categorization of financial information (as described below), which based on the categorization tool (18). The categorization tool (18) embodies a set of manual processes explained below, and also based on one or more templates based on accounting or bookkeeping parameters of businesses similar to Business A, includes one or more decision support processes that assist users in engaging in manual processes. The categorization tool (18) is also linked to the learning engine (24) explained below so as to automate certain processes such as categorization processes so as to streamline platform operations.

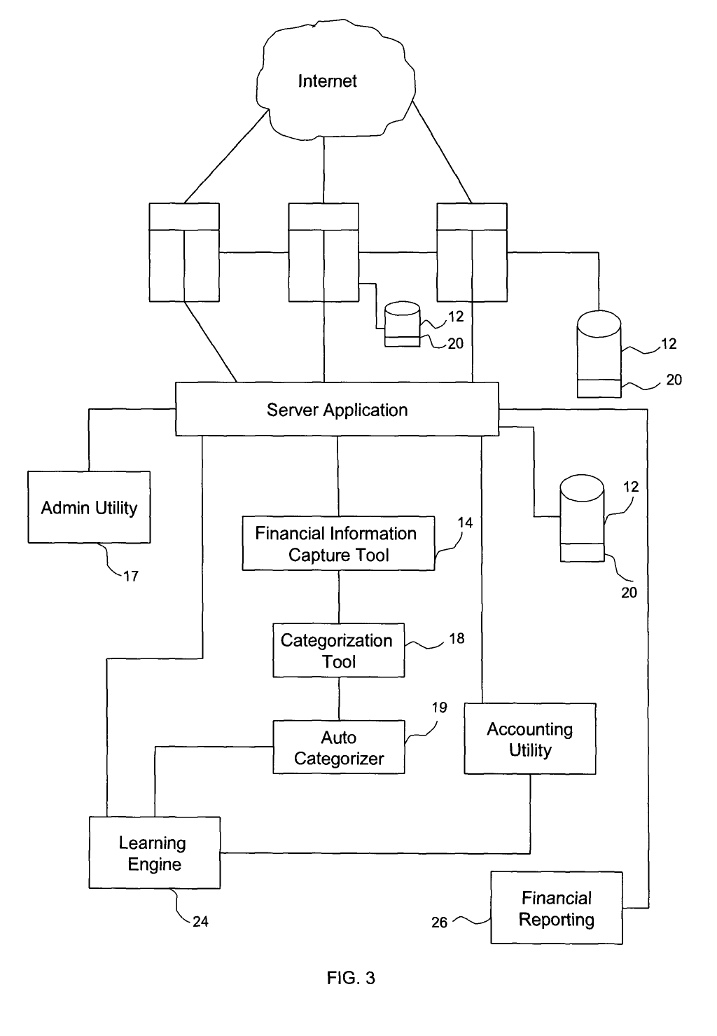

It should be understood that the web application (12) is able to build from information provided by users of Business A, and also to extrapolate from activities logged of the users to web application (12) a set of rules (20) related to the Business A (as shown in FIG. 3), which are stored to database (22), and these rules are configured by the web application (12) to enable both capture of financial information and processing of financial information by the accounting utility (16) so as to generate accounting information. It should be understood that the set of rules (20) is compiled by the web application (12) so as to define a profile associated with each business or entity registered to the web application (12) (corporation or individual—e.g. sole proprietorship—as explained below). The web application (12) is configured so as to use the profile for each entity so as to adjust the operations enabled by the platform on an ongoing basis.

The learning engine (24) supports the operations of the categorization learning tool (18) but also more broadly analyzes activities logged to the web application (12) by the various entities and derives insights as to operations relevant to the bookkeeping and/or accounting using the platform, based on entities with a similar profile. This enables the platform operations to be delivered in a more and more intuitive manner.

The learning engine (24) may be implemented based on state of the art machine learning technologies, as a skilled reader will readily understand.

In this way, the task of “teaching” the platform various aspects of the business of Business A that affect the correct capture of financial information, and processing of the financial information so as to generate bookkeeping or accounting information, for the support of bookkeeping or accounting processes, may be delegated to a person who is more familiar with bookkeeping or accounting practices and/or the use of the platform of the present invention. The web application (12) embodies a series of automated processes that thereafter enables the streamlining of operations enabled by the web application (12), which significantly reduces the time and training that may be required to use the platform of the present invention on a regular basis.

The present invention includes the specific platform architecture that enables these platform attributes and associated workflow, including delegation of setup activities, which in turn reduces the pain in user adoption, which in prior art systems constituted a significant barrier to adoption of accounting platforms, including Internet based accounting platforms. A significant aspect of the present invention, is that the platform embodies workflows and tools that enable day to day use of the platform of the present invention, as opposed to the current workflow in most organizations which involves (a) collection of financial information (for example organization of paper receipts without logging transactions or accounting for transactions on a regular basis, and (b) deferred processing of financial information, usually just in time based on a tax authority driven deadline, or often on a quarterly basis in a best case scenario. The deferral, in most small businesses, of regular logging of transactions and application to these transactions of accounting and/or bookkeeping practices results in a number of significant disadvantages.

First, receipts can be lost, information required to properly categorize for example expenses may be forgotten. Moreover staff may be busy on other projects at faced with the time pressure of bookkeeping or accounting deadlines, the time required to properly log transactions, and categorize transactions, so as to enable efficient application of bookkeeping and/or accounting processes, may not be available. Second, if transactions are not logged and categorized regularly then this deprives the business from the benefits of regular access to financial information, for example using one or more computer implemented reporting of financial planning tools.

In one aspect of the invention, the platform of the present invention provides a series of tools that enable the quick and easy logging and categorization of transactions, to the point that the logging and categorization of transactions, becomes as easy as placing receipts in one of several piles or boxes (which is in effect what small businesses currently do for the reasons explained). In a second aspect of the present invention, the web application (12) includes one or more financial reporting tools (26) that are operable to analyze the financial and/or accounting/bookkeeping information stored to the database (22). It should be understood that based on the platform operations described herein, this information will be more up to date than is the case if Business A is using prior art platforms or processes. This enables Business A to access more up to date, and more complete, information, which is advantageous to Business A, and may enable better financial planning and other aspects of the business operations. This further motivates Business A to ensure that their staff is using the platform of the present invention regularly, which in turn improves efficiency in supporting accounting/bookkeeping processes and in turn improve the information used by the financial reporting tools (26) even more.

In one particular aspect of the present invention, the financial information capture tool (14) is configured so as to enable the secure linking to online facilities used by Business A which may include information that can be used to enable platform operations, for example the categorization of transactions. The financial information capture tool (14) is configured to include functionality for extracting from third party platforms, and processing, categorization information that may exist for example in an online banking platform already, and map this category information to categorization operations enabled by the web application (12), including manual operations and automated operations enabled by the categorization tool (18). The financial information capture tool (14) is operable to extract this information securely, based for example on implementation of third party supported interfaces and use of secure transfer protocols. It should be understood that this functionality enables importing data directly from banks, credit cards, lines of credit and other financial vehicles. This reduces the need for digging through piles of receipts, laboriously and manually entering them and trying to make sense of it all. The upload functionality can pull in financial transactions, in many cases already categorized by type of expense, in near-real time.

In this way, it should be understood that the platform of the presenting invention is operable to take most of the pain out of bookkeeping based on its novel and innovative architecture, platform utilities, and platform operations. The present invention provides a useful technology and computer implemented method that enables business owners to organize their financial data and generate accounting information or bookkeeping information in a new and unobvious way. By doing so, the organized business owner becomes a better client for the accountant, possessing better information to hand over to the accountant when it comes time for taxes, audits, etc.

It should be understood that the accounting utility (16) is designed and configured based on rigorous application of applicable principles and standards. This enables users to save money, and by helping business owners do the record-keeping work completely and correctly, accountants and bookkeepers have become evangelists for use of the platform of the present invention.

The platform of the present invention provides better access to financial analysis by removing barriers to capture and organizing financial information in a way that supports meaningful financial analysis. When the unpleasant workload goes away (thanks to the transaction upload functionality described in greater detail below), and the users start getting financial insight that can help them run a better business, they look forward to doing accounting as much as any other part of their business processes.

The present invention removes the barriers to convert. Traditionally accounting packages are very “sticky” due to the pain of converting but they are typically also fundamentally unsatisfactory. The user experience enabled by the present invention makes it easy to get started and instantly see results.

In one aspect of the present invention, the web application (12) is operable to guide users through a simple and informative set of screens that are operable to map Business A from an accounting/bookkeeping perspective. This enables the web application (12) to build the rules (20) and associated profile. It should be understood, that the accountant or bookkeeper of Business A may be delegated this task.

System

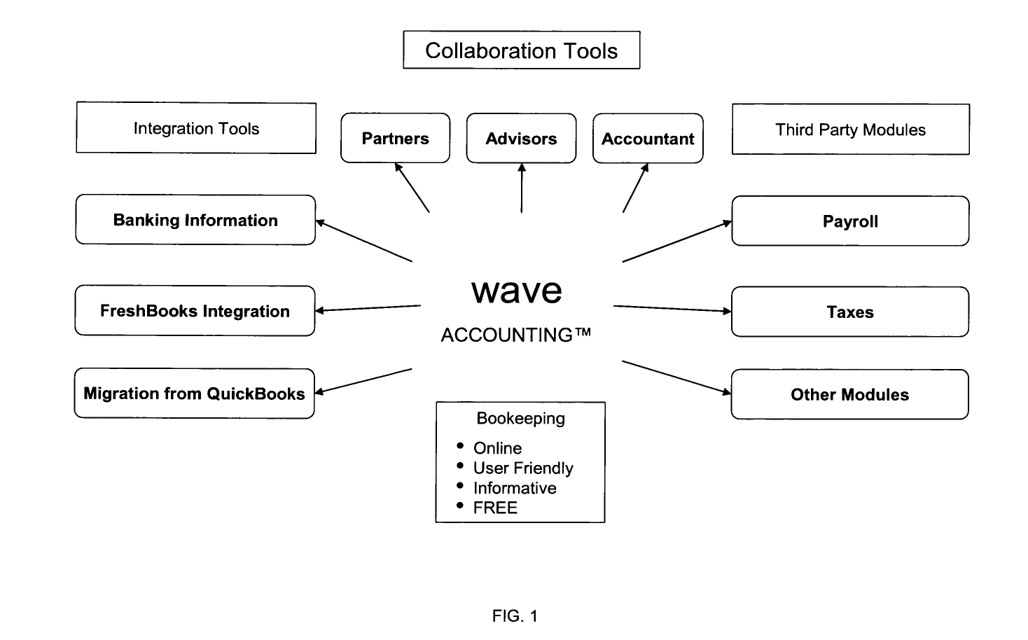

FIG. 1 shows a system in accordance with the present invention.

In one implementation of the present invention, the software platform illustrated in FIG. 1 has been designed and configured so as to enable enhancement and updating, thereby enabling constant innovation. In a particular implementation of the present invention, the platform may be built on DJANGO™, a programming language that permits fast deployment as well as stability under massive traffic volumes, and easy scaling to meet future demands.

The Internet implemented computer platform of the present invention enables a series of functions, some of which are described in greater detail below.

Financial Information Capture Tool (Bringing in FI Transactions into the Platform)

This section details some of the particular processes that may be embodied in the financial information capture tool (14).

Uncategorized Accounts—There are 2 special accounts in the standard chart of accounts that are manditory for all entities—Uncategorized Income (4000) and Uncategorized Expenses (5000)

entity—personal, business A, business B, etc.

related entity—the entity (personal, business A, business B etc.) that the FI is associated with

category—the CashEdge category code

active account—an account that has been added to the entity and is active

Autocategorized transaction—a transaction that the application assigns to an account that is not account 4000 or 5000.

Uncategorized transactions—a transaction that the application assigns to account 4000 or 5000

Archived transactions—a transaction that has been manually categorized (either from an uncategorized state or when the user overrides an autocategorized transaction to another account manually), a match has been accepted on (just another way of manually categorizing) or when an transaction's auto transaction has been accepted.

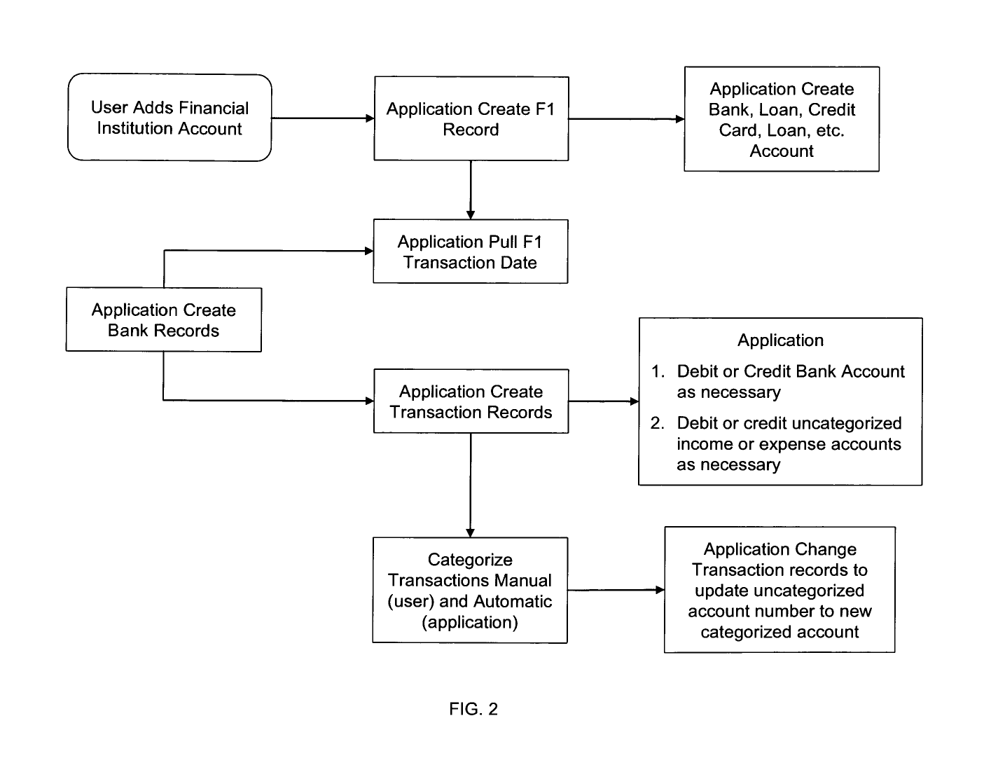

A representative workflow enabled by the present invention in relation to financial information capture, is explained in relation to FIG. 2.

Different Transaction Actions

Match a transaction—same functionality that exists for the current bank statement upload process however, we may want to expand the date range beyond what it currently is (maybe 120 days). Match searches should happen before categorization.

However, the new match process may post the transaction to to the bank and uncategorized (income or expense) until the user has accepted the match (currently nothing like this happens in the match process because it waits for the user to take action). We do not want to assume the match and mark an invoice or bill as paid until the user accepts the match to avoid possible confusion if the match is not correct.

If the user accepts the match then the transaction record is updated to change the transaction record to move it out of the uncategorized income or expense and into the correct account.

If a match is not accepted, an auto categorization run at that time. Another option is to run these transactions through the categorization with the other transactions and store the suggested account as a back up if the user does not accept the match.

The present invention may implement a a function that looks for matches for deposits based on combinations of unpaid invoices.

Create new transactions—After the data is pulled two transaction records are created for for each bank entry. The first is a debit or a credit of the bank account. The second is the offsetting debit of the uncategorized expense account (5000) or credit of uncategorized income account (4000)

Categorize transactions—Once the transactions are imported they may be run through the categorization engine. See below for different types of scenarios for how this will update the transaction records that are created during the create new transactions process.

Ignore a transaction—this should only occur if this is a transaction that has already been posted. Some examples include a match that is outside of the range (maybe there should be a tool to search for a transaction), a deposit that is for multiple invoices (that should be handled by splitting) or a duplicate. It is assumed that if they ignore a transaction the transaction records should be deleted with a warning.

Split a transaction—when this occurs the bank transaction record is not modified (still is for the full amount). The uncategorized income or expense transaction record is updated and the new transaction record(s) are created for the correct account. The transaction must balance.

Displaying the transactions—the current mock of the categorization screen hits most of the marks. There should be a section that allows you to select a specific bank account or transactions for a specific entity or all transactions within uncategorized, categorized and archived. Also the web application (12) is operable to provide a tab for all transactions regardless of their state. There should be no debit or credit listings just an amount column with plus and minus.

Descriptions and Vendors

In one aspect of the invention, a link is created between each expense and a vendor. In particular the platform creates a widget to link the description associated with the expense to an existing vendor or one that is created at the same time. This information is stored in the database (22) and used every time the description comes in for that business. This will allow for better visibility into the business activities in the future and allow for better mining of data for opportunities.

Manually Categorizing Transactions to a Different Entity—this will behave differently if we are dealing with a corporation (instead of a sole proprietor or partnership).

Further to the below set of rules, the user is provided the ability to alter a transaction once it has been categorized to another entity which means it can be switched to yet another entity. The process for doing this would be to delete the transactions for the shareholder loan and/or investment/withdrawal accounts and apply the new accounts as required based on the rules below. If they go further by also changing the category of the expense this simply alters the income or expense account.

As mentioned earlier, the web application (12) may implement one or more templates that are based on accounting or bookkeeping related attributes shares by groups of entities, for example “corporations”, however the web application (12) includes functionality for creating sub-groups based on type of business for example. The examples below illustrate the incorporation of accounting/bookkeeping best practices into the functionality of the web application (12).

Corporations:
expense to personal
   The bank is credited
   Corp's Shareholder Loan account is debited
   personal expense account is debited
   personal owner investment account is credited
expense to other corp
   The bank is credited
   Corp's Shareholder Loan account is debited
   Other corp's expense account is debited
   Other corp's Shareholder Loan account is credited
expense to other non-corp business
   The bank is credited
   Corp's Shareholder Loan account is debited
   Other business's expense account is debited
   Other business's owner investment account is credited
income to personal
   The bank is debited
   Corp's Shareholder Loan account is credited
   personal income account is credited
   personal owner drawings account is debited
income to other corp
   The bank is debited
   Corp's Shareholder Loan account is credited
   Other corp's income account is credited
   Other corp's Shareholder Loan account is debited
income to other non-corp business
   The bank is debited
   Corp's Shareholder Loan account is credited
   Other business's income account is credited
   Other business's owner drawings account is debited

Partnerships and Proprietorships
Expense to other corp
   The bank Account is credited
   owner drawings Account is debited
   Other Corp's Expense Account is debited
   Other Corp's Shareholder Loan account is credited
Expense to other non-corp
   The bank Account is credited
   owner drawings Account is debited
   Other business's Expense Account is debited
   Other business's owner investment account is credited
Expense to personal
   The bank Account is credited
   owner drawings Account is debited
   Personal Expense Account is debited
   Personal owner investment account is credited
Income to other corp
   The bank Account is debited
   owner investment Account is credited
   Other Corp's Income Account is credited
   Other Corp's Shareholder Loan account is debited
Income to other non-corp
   The bank Account is debited
   owner investment is credited
   Other Corp's Income Account is credited
   Other business's owner drawing account is debited
Income to personal
   The bank Account is debited
   owner investment Account is credited
   Other Corp's Income Account is credited
   Personal owner drawing account is debited

Personal
Expense to other corp
   The bank is credited
   Personal owner drawings account is debited
   Other corp's expense account is debited
   Other corp's shareholder loan account is credited
Expense to other non-corp
   The bank is credited
   Personal owner drawings account is debited
   Other business's expense account is debited
   Other business's owner investment account is credited
Income to other corp
   The bank is debited
   Personal owner investment account is credited
   Other corp's income account is credited
   Other corp's shareholder loan account is debited
Income to other non-corp
   The bank is debited
   Personal owner investment account is credited
   Other business's income account is credited
   Other business's owner drawings account is debited

Auto-Categorization

In another aspect of the invention, the web application (12), and more particularly the categoriation tool (18) enables auto-categorization features, some of which are explained below.

When Do You Not Try to Categorize a Transaction?

Match—if a transaction has a suggested matched (see above) to an already entered transaction (for example a deposit to the bank matches the amount of an invoice) it may not be categorized as the match process will assume the accounts that should be associated with that transaction.

Auto-Categorized Transactions that Just Need to be Moved to a Different Entity

Using the drag and drop tool the user may be able to simply drag it to the title of the entity to move it to that entity. This assumes that the categorization does not need to be altered.

How to Associate Categories to Accounts

In the chart of accounts there is a listing of CashEdge account categories that are tied to accounts. A category can be related to one account or many. An account can have one category or many and/or a range of categories.

From the transaction a category code may be provided. You will have to query the chart of accounts and look for the accounts that they are related to. Once you have the list of possible accounts to associate a transaction to you will have to take an action based on the following scenarios.

How to Categorize a Transaction in Different Scenarios

This section illustrates possible logic embodied in the categorization tool (18).

Step 1:

Check to see if any rules exist for this user:
Reference the rules section explained below.
If a transaction matches a rule then it becomes categorized automatically based on that rule.
Create a transaction record that affects the bank.
Create a transaction record that affects the account(s).
Mark the transaction as categorized or archived based on the applicable rule.
This would end the categorization.

Step 2:

If category related to 1 active account in related entity:
This is a categorization match.
Go to step X.

Step 3:

If category related to more than 1 active accounts in related entity:
This is a near match.
This creates a list of possible account matches.
See if the description of the transaction matches any previously categorized transactions in that entity.
   If so and that there is only one account that the description has been matched to in the past and that account is in the list of possible matches then it is a match. Go to step X.
   Common Process: If so but there are more than one account that has been matched to that description and those accounts are in the list of possible matches then the possible account matches is reduced to those accounts. If the description has been categorized in the past and it has been categorized to more than one account (i.e. Loblaws has been categorized to groceries and entertainment in the past) and both groceries and entertainment are in the list of possible matches then the list of possible matches is reduced to groceries and entertainment.
      Of this subset if there is one account that has more transactions matched to it then choose that account and go to step X
See if the description of the transaction has intelligence from the rules engine.
   if so categorize with the intelligence rules and go to Step X
   if not mark as uncategorized and go to Step X

Step 4:

If category is related to 1 active account in related entity and 1 or more active accounts in non-related entity. This is the same as Step 2. It is a match. Go to Step X.

Step 5:

If category is related to no active accounts in related entity and 1 active account in non-related entity This is a match to an unrelated entity. Go to Step 6.

Step 6:

If category is related to no active accounts in related entity and more than 1 active account in non-related entity:
See if the description of the transaction matches any previously categorized transactions for that user's other entities
   if there is one account that this has been matched to in one business then this is a match to an unrelated entity. Go to step X.
   If there are multiple accounts that the description is matched to in one business then follow common process 1. If a match is found it is to an unrelated entity.
   If there is more than one entity that has this description associated with at least one account then mark the transaction as uncategorized and go to step X
See if the description of the transaction has intelligence from the rules engine
   if so categorize with the intelligence rules and go to Step X
   if not mark as uncategorized and go to Step X

Step 7:

If category is related to no active accounts in related entity and no active accounts in non-related entity:
See if the description of the transaction has intelligence from the rules engine
   if so categorize with the intelligence rules and go to Step X
   if not mark as uncategorized and go to Step X

Step X:

Save the data to the transaction record:
Create a transaction record that affects the bank
If category is determined create a transaction record that applies the transaction to the accoumanuant. Do this for the entity that it is matched to.
If category is determined mark the transaction as categorized
If category is not determined create a transaction record that applies the transaction to account 4000 or 5000
If the transaction is for an entity that is not the default entity for the bank account then there needs to be some type of visual cue to the user that it is going to another entity outside of the related entity. The rules for posting the transaction to other entities must be followed.
If category is not determined mark the transaction as uncategorized on the database

How are Auto Categorized transactions displayed and what can a user do with them?

Display
These transactions are on the categorized tab of categorization screen linked to the categorization tool:
   They will default to be listed in date order starting with the most recent
   A mechanism is provided to enable identification of the account that the transaction has been categorized to
   Users may override the categorization in place—for example changing it to another account including uncategorized.
   Users may approve the categorization. This can be done individually or using a multi-select process or approve all. All transactions should be approved by the user (best practices) at which time they will be moved to archived. A transaction being approved or not should have no impact on how the transaction is treated in the application other than how it is displayed in this screen.
   The user can select an individual entry or use multi select or choose select all and press confirm categorization. This will move the transaction into archived (see below for that process).
   The user can select an individual entry, use multi select or choose select all and press mark as uncategorized to override the categorization that was done (see below for that process).
The web application (12) is operable to enable transaction listing that will sort by date, description, credit amount or debit amount.
   A filter may be applied to the transaction listing that include date range, description, amount (should not be credit or debit should be +/−)
Auto-categorized transactions may also be available to be viewed on the income and expense landing pages in the lists
   The transactions will be saved similarly to the transactions created using the current bank import process so they should be able to be viewed the same way as those transactions.
Auto-categorized transactions may also be included in all of the dashboard widgets.
   They should be included in data presented in any dashboard widgets or graphs like any other financial information. Given that these record will be stored using our current transaction model I assume this will work by default.

Approving an auto categorized transaction:
The transactions that are approved by the user (explained above):
   They will have to be marked as approved in some way so they can be properly identified in the future.
   These will then automatically be removed from the categorized list and now be available in the archived list.
   The transaction will still be available to be viewed around the application as they were previously.

Overriding auto categorized transactions:
When a user does not want the transaction to be categorized the way that the app has done it
   The user can change this to uncategorized individually, multi-select or all using the process described above.
   The user can change the category by dragging it to another category. This behaviour should be treated the same as if the user was categorizing an uncategorized transaction (see that section). The only difference here is that the account that the transaction is associated will not be 4000 or 5000.
   The user can change the transaction to another entity by dragging it onto the entity name (the entity name is only active for this task on this screen and not on the uncategorized screen)

Splitting a categorized transaction:
When the application has categorized a transaction and the user wants to split it into more than one account. See the main process for splitting transactions below. This listing differs from the main scenario as follows:
   The first line may have the account default to the account that has been auto categorized (meaning if it is categorized as groceries the first line's account should be groceries)
   When a user creates a split for a categorized transaction it will become uncategorized. However, we do not want this to move to the uncategorized section (like it would if it is changed to uncategorized) unless the user leaves this screen in which case it would be marked as uncategorized if they have not finished categorizing it.
   The rest of the rules for splitting may be adhered to.

Duplicate Transactions:
The web application (12) includes functionality for marking a transaction as a duplicate (just in case)
   this should be able to be done individually, multiselect or select all.
   when a transaction is marked as a duplicate it is removed from the transaction table (maybe just similar to a delete indicator only it is a duplicate indicator). This should update the bank account and the other accounts associated with the transaction.
   user should receive a warning saying that the transaction will be removed from their bank statement and will impact the running total of their account.

Manual Categorization

These are transactions that the auto categorization in accordance with the categorizaton tool (18) was unable to successfully categorize or the user has altered to make uncategorized. These are stored in accounts 4000 or 5000. This includes matched transactions (as described in the match section above)

Display
These transactions are on the uncategorized tab of categorization screen.
   They will default to be listed in date order starting with the most recent
   The transactions are simply listed with the date, description and amount (should not be credit and debit should be +/−)
   Transactions that are matched would also be displayed here (same display rules as currently in bank import)
   User will be able to drag an individual, multi-select or all of the transactions to a category
   User will be offered the ability to set up a rule for that vendor (description) so that it can be automatically categorized in the future.
   User will be offered the ability to categorize all of the uncategorized transactions that share the same description to the same category. It would be nice if the number of those transactions is displayed to the user.
   There should be sort functionality associated with the transaction listing that will sort by date, description, credit amount or debit amount.
   There should be a filter that can be applied to the transaction listing that include date range, description, amount (credit or debit).
   Users will be able to split a transaction into multiple categories (see below and specs for splitting).
They will also be available to be viewed on the income and expense landing pages in the lists
   The transactions will be saved similarly to the transactions created using the current bank import process so they should be able to be viewed the same way as those transactions.
They will also be included in all of the dashboard widgets.
   They should be included in data presented in any dashboard widgets or graphs like any other financial information. Given that these record will be stored using our current transaction model I assume this will work by default.

Categorizing
users will categorize by dragging them to an account on the left side of the screen.
   this screen will have a listing of personal, business A, business B etc. (will need to figure out how this will work if there are a lot of accounts and/or businesses as it could get busy).
   the user will be able to drag individual, multi-select or all of the transactions.
   the transaction will be changed updating the accounts as necessary.
   the transaction will be moved to the archived section and should be marked as such on the database.
   if the transaction is moved from one entity to another it will have to follow the rules provided earlier in the document.
   the user will be asked if they want to set up a rule.
   the application will track the categorization using the categorization algorithm to get smarter (see specs below).
   Since the transaction is not categorized the user can not drag the transaction onto the entity name. It must be dragged onto the account name that is listed under the entity.

Split Transactions:
splitting transactions will follow the rules for split transactions.

Duplicate Transactions
There needs to be a way for the user to mark a transaction as a duplicate (just in case)
   this should be able to be done individually, multiselect or select all
   when a transaction is marked as a duplicate it is removed from the transaction table (maybe just similar to a delete indicator only it is a duplicate indicator). This should update the bank account and the other accounts associated with the transaction.
   user should receive a warning saying that the transaction will be removed from their bank statement and will impact the running total of their account.

Archived Transactions

How are Archived Transactions Displayed and What can a User do with Them?

Archived transaction work exactly the same as autocategorized transactions only they have been approved.

If they are later changed to uncategorized then the account is updated to the proper account (4000 or 5000). This holds true for a split transaction if one of the splits is changed to uncategorized.

If the user changes the transaction to a different account it works the same way as overriding an autocategorized transaction.

Handling Sales Taxes

Sales taxes should be able to be entered for all transactions the same way that they work currently in the bank import.

If a user has not updated the tax and categorizes a transaction to an account that has a default tax(es) associated with it the tax is automatically reverse engineered.

If a transaction has been autocategorized and the account has a tax associated with it the tax is automatically reverse engineered and the user can click on the tax drop down and view or edit it.

If a transaction has had a tax amount added to the transaction (either manually or because of a rule or because it is associated with an account that is associated with a tax) and then a user decides to split the transaction the tax needs to be dealt with.
It should be assumed that the same tax will apply to all the splits unless the user manually changes them. This means that when the user presses split the tax widget will activate for the same taxes previously selected.
If the user has overwritten the default amount with a manual entry the dispersment of the tax amount is impossible to determine. Some type of indication that the tax has not transferred down to the splits should be made (maybe just say you have $X.XX of GST to put into your transactions and have it alter as the user enters the data disappearing when it is finally at 0)

If the transaction is split and has taxes on the split transactions and then the user deletes the splits, the amount of the taxes should transfer up to the transaction and be allocated to 4000 or 5000 (because it will no longer be categorized)

Other Areas of the Application Impacted by Categorization

Dashboard Widgets
dashboard widgets that deal with amounts within accounts are operable to reflect accounts 4000 and 5000. Income and expense widgets should include these.

Transaction records
The rules for dealing with transactions and categorization are dealt with above
If a transaction moves from one entity to another and the user wants to view the transaction it will show all of the related transactions (drawings, investment etc.) with the exception of personal transactions which will never display the drawing or investment accounts.

Reports
Accounts 4000 and 5000 will need to be included in all reports and dealt with like any other income or expense account.
If someone clicks on a transaction for a 4000 or 5000 account it should take them to the categorization screen where it would be the only one shown (filter by description, date and amount)

Split Transactions

This occurs in the bank transaction data in the categorization screen, the bank import screen and would be great if we can do this in the fast entry screen too.

One of the differences over prior art solutions is that we will not ask the user to select the account in the splitting area. We are only splitting the number and indicating the tax. The account is added when the user drags one of the splits to the category.
When a user is working on a transaction they will be shown a split button or link
The interface should open with 2 different lines (default assumption that the user will only split the transaction in 2 but have the ability to split into more by using the split button again which will create a subsequent line for data entry—the split button should be beside the split lines)
The accounts (or categorization) are added by the user dragging and dropping the split portion of the transaction into a category (just a granular use of the regular drag and drop functionality). The user does not select the accounts in the split interface only selects the numbers and taxes.
Once the user adds an amount of the first line the amount remaining should be put on the second line.
If the user changes the second line amount before changing the first line amount it should update the first line amount
Autocalculation is only done once so if an amount is updated on a line one and line two is autocalced and then overwritten buy the user and the total of the two lines does not equal the total of the transaction then it does not autoupdate any other lines.
If the user adds a third line (or more) no auto updating is done from that point on.
There is a running total of the amount outstanding. This is the amount of the transaction minus the amounts entered from the splits.
Once it is saved the transactions should not be displayed separately (line Mint does) we should display the total of the transaction in the bank and show the details of the split under that. The details have the ability to be dragged into a category and the top level of the transaction does not have this ability any more.
Once it is dragged to an account the account is somehow displayed to the user (like it would work for an autocategorized transaction)
If a user does not categorize all of the splits it is still considered an uncategorized transaction until all of them are categorized. We should save the work that they have done (displaying the split as above).
Users will be able to add a tax rate to each of the lines for split transactions which will reverse engineer the tax amount which should be able to be edited. This is the same functionality that is available in the bank import screen currently.
When the split transaction is saved the amount of the transaction that is applied to the bank MUST equal the total of the transaction. It is important that the bank always reflects the actual amount of the transaction and not the pieces of the transaction.
The individual income or expense line items from the split should be updated to reflect the proper amount and proper account. These also must be saved in a way so that they are all associated together so that when a user views the split transactions in the future all of the pieces of the transaction are displayed.
The date of the transaction is the date from the bank statement.

Aspects of Learning Engine (24) Used in Categorization

The following illustrates some of the aspects of categorization that may rely on operations of the learning engine (24):

check for dollar match from outstanding entries
Check the user's transactions to see if there is a match with the current amounts.
Check to see if there is a combination of entries that match the amount.
If there is a match then add this as a suggested match check for description match on all previously categorized entries
if the description matches a transaction that has already been categorized in the past then add this as a suggested match

If no matches add the description to the database (incrementing the count if it already exists)
check the database to see if we have that financial institution & description already recorded
if not add the financial institution and description
if yes increment the count by one check the description matrix
check to see which accounts have been categorized to this description
check to see if any match accounts that exists in that business
if more than one match choose the one that has the most categorizations counts
if there is a match suggest the best account
if no matches then leave as uncategorized

User categorizes the transaction
add the account that it is categorized to
if this already exists then increment the count

Auto Categorization Engine

As explained earlier, one aspect of the categorization tool (18) is that it includes or embodies one or more automated categorization operations. The categorization tool (18) may be understood to include an auto-categorization engine or auto-categorizer (19), which may for example be implemented as described below.

Requirements

The purpose of the auto-categorization engine is to relieve the user of the burden of having to manually categorize every single bank transaction by dragging it into its respective account in the system.

In the ideal situation, the auto-categorizer will take care of the most of the transactions, with the user only having to categorize a few transactions once in a while, and by operation of the leaning engine (24) the number of transaction requiring manual categorization will decrease over time.

The auto-categorizer is configured and implemented so as to be able to analyze a significant number of records constituting financial information sets and also interactions between users and particular financial information sets (such as transactions), in order to provide support for decisions made by the categorization tool (18) on an automated basis.

A skilled reader will readily understand that the categorization logic that may be embodied in the auto-categorizer (19) can be potentially be complex. It is important however that the auto-categorizer (19) include one or two more basic functions, which are explained below and illustrate the functionality of the auto-categorizer (19). A skilled reader will also understand that the functionality related to automated categorizing may be further developed using best practices based on data processing automation, and also may need to be updated from time to time based on changes in accounting and/or bookkeeping best practices.

Overview

The auto-categorizer (19) is based on a rules-based approach (as further explained below) to categorize records automatically as they are pulled from the user's financial institutions for example by operation of the financial information capture tool (14). The rules will be either explicitly defined by the user (user-rules), pre-loaded into the system based on CE category mapping (category-rules), or created automatically as a result of the user manually categorizing transactions (auto-rules). The web application (12) therefore is configured so as to monitor and analyze users' decisions over time, it will be able to categorize transactions more and more accurately by operation in particular of the learning engine (24).

Categorization Process

Here's a birds-eye view of the process flow for record categorization. The major steps are discussed in detail below.
Get transactions from CE (part of the financial information capture process or “FI process”).
Re-fetch the transactions to get merchant codes (needs to be added to financial information or “FI”).
Match invoices/bills/transfers (done outside of auto-cat).
For each transaction:
   Match against user-defined rules. If match successful, done, otherwise:
   Match rules for current business. If match successful, done, otherwise:
   Match rules for related businesses. If match successful, done, otherwise:
   Mark transaction as uncategorized, move on to the next one.

Match Rules for Current/Related Businesses

This part of the process may be applied twice. At first it will only use the rules defined for the current business. If no match is found, the search will be expanded to rules that match related other businesses. The process may be implemented as as follows:
Get rules that match the bank record's CE category.
If there is only one rule, we're done.
Narrow down rules based on bank record's description.
If there is only one rule, we're done.
If multiple rules match, and they're all from one business.
   Order the rules by relevance
   Apply most relevant rule, done
If couldn't match against any rules, mark transaction as uncategorized.

Rule Relevance Ordering

If a situation arises where multiple rules apply to the transaction (which means that both the CE category and the description of the rules match the transaction), the rule that is most relevant may be picked by operation of the auto-categorizer (19).

The relevance of the rule is determined by the number of times the rules was applied (match count). For example, if Rule A was applied to 10 transactions previously while rule B was applied to 5, rule A has higher relevance. If there is a tie, the rule that was used most recently will be picked.

What Happens When the Rule is Applied

When the rule is matched to the transaction, the auto-categorizer (19) may initiate the following operations:
The transaction is categorized according to the rule (using the same backend that powers manual categorization).
Match count is bumped and the last match date is updated on the rule.
The match decision is logged in the database for diagnostic purposes (more on that later).

Creating Category Rules

Category rules are based on the mapping between CE categories and standard accounts defined in a Chart of Accounts. Thus these rules may be (re)created when the Chart of Accounts is (re)loaded.

Creating Auto-Rules

Automatic rules are created as a result of user actions. When the user manually categorizes a transaction, the web application (12) is operable to perform a look up function if a rule that matches this categorization already exists in the rule engine. If there is such a rule, its match count and last match date are updated. Otherwise, a new rule is created.

Data Organization

The web application (12) may use a table to store applicable rules (20) in the system. The table may include the following columns:
Rule type (user, category, auto)
Business
CE Category
Description
Target account
Match Count
Last Match Date
Created Date—not strictly necessary but useful for debugging auto-cat decisions

The web application (12) is operable to create indices on type, business, category, and description to make sure that rule lookup is as fast as possible.

Logging

Every auto-categorization performed by the auto-categorizer (19) may be logged for the purpose of diagnosing the auto-categorizer's (19) decision making. Given enough data, the categorization log can be mined for interesting information by operation of the learning engine (24).

The following illustrates the information that may be stored to a log:
Matched rule
Bank Record
Date
Match stage

Match stage, above, records the stage of the auto-cat process at which the rule was matched. This is something that the auto-cat code will keep track of and record when the matching rule is applied.

For now, we can use the database for storing the logs. However, because the amount of data will grow steadily (there will be a log entry for every transaction that was auto-categorized), it is worthwhile to think about moving the log table to a different database in the future.

Parallel Evaluation

The auto-categorization pipeline must be as fast as possible. Even though the rules-based engine is very fast in comparison to looking at the raw transaction data, its throughput is still limited by the fact that it categorizes one transaction at a time. In one enhancement of the present invention, groups of transactions are analyzed at a time in order to improve performance. For example, if several transactions have the same business, CE category, and description, we know that the categorization decision will be the same for all of them.

Matched Transactions

In a particular aspect of the present invention, matched transactions are displayed by the web application (12) on the same screen as the uncategorized transactions partially in order to provide the opportunity for further tuning of matching based on display of transactions that have been successfully matched and those that have not so that the user may provide feedback that may enable the system to further improve the automated categorization processes enabled by the present invention.

For this reason, the uncategorized portion of the screen displayed by the categorization tool (18) may enable the following, in part to also ensure that the display remains uncluttered so as to enable the users to provide feedback that may be useful for the purposes of improving or tuning categorization:
If a transaction has a suggested match it is at the top of the list.
The transaction having a suggested match is also highlighted in some way for example by using a different colour background.
The tax and split links may not be displayed.
The check box may not be displayed.
There is a link that says something like ‘matched to account name & date’
There are buttons that say accept or reject (or whatever is a better alternative).
If the user accepts the same functionality that is currently done in the bank import for example, this is executed and the transaction is removed from the screen and put into the archived section.
If the user rejects the match, it is permanently removed and the transaction reverts to a standard display. However, the transaction remains at its position at the top of the list because that could be confusing to the user who may want to categorize it right away because they obviously know where it belongs. The exception is when a user leaves the screen without categorizing the transaction and then returns—in this case the transaction will be in chronological order treated the same way as all other uncategorized transactions.

Account Transfer Specs

When a user has 2 or more bank accounts the possibility exists that they will transfer amounts between the accounts. This can be an electronic funds transfer between two bank accounts, a payment or advance against a line of credit or credit card, a check going from one account to another. When this happens the account that is receiving the money will have a positive transaction and the account paying the money will have a negative amount. In this situation the user has the ability to drag and drop both transactions which will create two transactions instead of one. The web application (12) includes a process for handling this type of situation.

The platform of the present invention provides includes a match process build to search for these possibilities. Because the amounts will be the same and the dates should be very close we can look for times when the amounts are offsetting between two accounts within a 20 day period. When this occurs we have a basic transfer happening. The logic for this should be a debit for the account receiving the money and a credit for the account paying the money. No other transactions will be required here. It may still be important to give the user the ability to say that it is not a transfer (as we could get false positives) which will reverse the transactions and then put amounts into uncategorized income or expenses. When there is a match and it is confirmed it should move both transactions into archived, if it is not accepted it should change both transactions at the same time. The key for this to work smoothly would be for the two transactions to be joined at the hip until the user says that they are not. This will have to span all accounts that the user has regardless of the entity they are associated with. If it is cross entity transfers the logic for that should be the same as all other transactions utilizing the investment/drawing and shareholder loan accounts.

In the event that the above process does not capture a transfer (could be because one account is not imported or the transfer spanned a longer period) we need to be able to let the user do this manually. The tool box on the transaction should have a transfer button that will allow a manual matching for a transfer. The process should be as follows. The user will be presented with a pop up or something AJAX'd that will display the amount and the account in question. They will then select the other account that the money either went into or came out of. Once selected they press submit and the transaction is recorded as detailed above.

An edge case of the manual process is that the account that was selected could have their data imported later which may contain that transaction and the match process will need to handle this.

Other Scenarios for Transfers:

Payments to a credit card (or loan that is an FI)

You make a payment to your credit card using your bank account and when you land on the Transactions screen you see both a negative for your bank account and a positive for your credit card.

Transfer from One Bank Account to Another

This is similar to the transfer from bank to credit card. Because both bank transactions (increase and decrease) will be listed on the Transactions screen under the Uncategorized tab.

Revenue Streams

In one aspect of the present invention, access to the service may be provided for free in order to build the on-line user base and enable the possible revenue models described above.

The operator of the platform may derive revenue from registered users accepting offers from advertisers, of which the operator receives a percentage.

People expect online applications to be free but traditional accounting application providers are stuck in a pay-for-use model, or at best a service that is partially free (free for limited functionality, or free as a teaser). Many models exist for monetizing online applications such as Gmail or Mint—both very successful cloud applications with no cost to the user. In exchange for a good, free product, people are willing to entertain intrusions (like advertising or promotional messages), particularly if the intrusions are transparent and relevant to the end user.

Monetizing small business accounting data is worth more than selling accounting software. Free is great for getting registered users that will provide data, and data is great for revenue. There are two primary streams of revenue that Wave will pursue; one from mining data and the other from integrating complementary applications.

Revenue Stream #1: Data

Wave will be in a unique position to leverage data from a user's accounting information, and to aggregate the data from thousands of users combined, while observing strict guidelines on privacy and security.

Access to a small business's financial information provides detailed and timely information on what goods and services they use, the amount they spend and the timing of spending decisions. This is extremely valuable data for advertisers that want to reach the small business market efficiently and effectively. By building a sizable small business user community Wave will have the leverage to ask advertisers to offer better promotions to the Wave community. Those promotions will be delivered directly to the small business decision maker at exactly the time they need them. For instance, if the system detects that a business owner is spending X on

Internet hosting, and an advertiser offers the same service at a lower cost, Wave can present the offer to the user at the relevant time.

Initially the revenue will be achieved on a cost-per-acquisition basis. As users execute promotional offers Wave will get a percentage of the transaction. As the user base scales Wave will charge a flat fee to show an offer, plus a cost per acquisition on conversion.

Many organizations will pay for aggregate data about the finances of small businesses, such as how much, on average they spend on their services. By aggregating financial information and trends relating to small businesses, Wave becomes a premier source of intelligence about the habits of small businesses and entrepreneurs that it can monetize as syndicated information, virtually in real time.

Wave's relationship with small businesses provides an ideal means for an organization such as Ipsos Reid to engage small businesses in opt-in research panels. Small business owners would choose to participate in exchange for an incentive or a first view of the information gathered.

Revenue Stream #2: Premium Services

For the foreseeable future WaveAccounting.com will remain a free online bookkeeping service. There are a number of other related accounting services as detailed in FIG. 1 that Wave will partner with to provide a more complete accounting experience. External modules may include:
payroll
inventory management
web payments
etc.

These add-on modules will have a monthly fee associated with them.

Additional Revenue Streams

Once Wave is successful at capturing a sizeable user base of small business owners there are multiple other revenue opportunities to explore, including:
Providing a white-label solution for financial professionals (accountants, bookkeepers, etc.) with a fee per user to the professional firm.
Providing a white-label solution to other financial firms marketing to small business owners.
Providing an electronic bill payment module and taking a percentage of each transaction.

Advantages

For the small business owner WaveAccouting.com represents a significant improvement over their current accounting options as it was designed with their needs in mind. Its robust, intuitive, easy to use, informative and most importantly, its free.

For advertisers, Wave represents an avenue to reach a large and important market with very targeted messages at exactly the time when they are most likely to act.
Spend less time on accounting
Get better information with which to run their business
Constantly collaborate with internal and external advisors
Provide their accountants with more complete information
Spend more time focusing on their core business

Features of the Platform Include:
Simple, intuitive user interface
Core bookkeeping module
Integration with third party modules (payroll, taxes, etc.)
Automated integration of banking information to remove the manual pain of bookkeeping
Easy migration from competitive accounting packages
Integration with products targeting the same market
Ease of collaboration with internal and external stake holders
Scalability
Automation of key features that are barriers to adoption such as for example auto categorization

Computing Environment

The description above discloses at a high level the various functions of the proposed control/management solution for a plurality of devices at the location.

In order to provide additional context for various aspects of the subject innovation, the following discussion are intended to provide a brief, general description of a suitable computing environment in which the various aspects of the present invention can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer (such as the computer(s) illustrated in the architecture described above) typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system of the present invention represents a collection of hardware and software elements that enable a user to manage a variety of device and information objects associated or generated by these devices, leveraging in-the-cloud resources in a new way.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It should be understood that the present invention may be extended by linking the invention with other technologies or processes useful in the monitoring, control or management of a variety of devices, for a variety of purposes.

We claim:

1. An Internet network implemented system for providing computer-implemented accounting services characterized in that the system comprises:
(f) an external cloud based computing system defining a cloud based computing environment that is operable to provide access to one or more subscribers to one or more computer-implemented accounting or bookkeeping services;
(g) the cloud based computing system defining:
(i) a financial information capture tool that is operable to (A) capture financial information from one or more remote Internet connected platforms, sources including based on captured user interactions relative to financial information capture and/or business processes based on analysis of such captured user interactions, and enable one or more users or subscriber users to otherwise provide financial information, (B) enable the definition of a profile based on the business of a subscriber business or subscriber profile;
(ii) a categorization tool, linked to the financial information capture tool, that enables the categorization of financial information based on the subscriber profile and also based on one or more accounting or bookkeeping processes linked to the subscriber profile, wherein the categorization tool enables: (A) automated categorization of financial information, and (B) if automated categorization of particular financial information did not result in a categorization, then enables manual categorization of the particular financial information; and
(iii) an accounting or bookkeeping utility that is operable to process the categorized financial information based one or more accoutring and/or bookkeeping processes associated with the subscriber so as to generate, and enable the subscriber to access, accounting information or bookkeeping information.

2. The system of claim 1, characterized in that the cloud based computing system further defines learning engine that implements one or more machine learning processes that enable:
(a) the automated categorization of financial information;
(b) the analysis of automated categorization of financial information, including based on user feedback (including manual categorization of financial information by the user or users), so as to alter the automated categorization processes associated with the subscriber; and/or
(c) the modification of the subscriber profile based on learning from user interactions with the system, and processing of financial information for the subscriber, including automated categorization of financial information.

3. The system of claim 2, characterized in that the cloud based computing system further defines an administrative utility that enables a subscriber business to delegate user activities related to the system to one or more accountants or bookkeepers, which enables such delegates to teach the system and thereby enabling the use of the system by subscriber staff to be streamlined.

4. The system of claim 3, characterized in that the system is configured to enable subscribers users to provide or categorize financial information required for accounting and/or bookkeeping processes in an efficient way, and the system thus is able to build and maintain an up to date financial information for the business.

5. The system of claim 4, characterized in that the system further defines one or financial analysis tools that enables the subscriber users to generate up to date financial reports on an on demand basis.
